(19) United States
(12) Patent Application Publication
(10) Pub. No.: US 2016/0231581 A1
(43) Pub. Date: Aug. 11, 2016

(54) Multiple Laser Optical Assembly

(71) Applicant: Bin Liu, Camarillo, CA (US)

(72) Inventor: Bin Liu, Camarillo, CA (US)

(21) Appl. No.: 14/616,882

(22) Filed: Feb. 9, 2015

(51) Int. Cl. G02B 27/28

(52) U.S. Cl. CPC G02B 27/283

(57) ABSTRACT

A multiple laser optical assembly comprises two laser subassemblies with two lasers bonded on two bases respectively, a polarization beam combiner (PBC), a lens, a mechanical housing and an optical fiber. The two subassemblies are configured to have orthogonal polarization directions from the two lasers and are assembled coaxially. The PBC combines the orthogonal polarized beams from the two lasers. The lens focuses the combined beam and couples into the optical fiber. With such a two laser optical assembly as a building block and a wavelength division multiplexing (WDM) filter to combine the beams from two of such type of two laser optical assembly, one can further build a four laser optical assembly and extend to even more channel multiple laser optical assembly by adding more WDM filters and more similar two laser optical assemblies.

### FIELD OF THE INVENTION

This invention relates to optical assembly in optical communication field. Particularly, this invention relates to a compact optical assembly with multiple semiconductor lasers coupled into a single fiber for high speed optical communication.

### BACKGROUND OF THE INVENTION

With the wide adoption of smart phone, high definition television and other bandwidth heavy applications, the current optical networks are challenged more than ever to accommodate the exponential traffic growth. Among the obvious options, lighting up more fibers is one of them. Yet this approach will involve installing addition fibers and hardware making this option inadequate and expensive. Another choice is to increase the transmission speed of single carrier. Yet this approach will involve the expensive hardware upgrade and face more technical challenges. The third approach is to stack more wavelengths to existing fibers. This approach will have no need of installing new fibers and have minor hardware modification. Thus, it is more economic and quick solution and has been the main path to expand the capacity of current network. To input multiple wavelength signals into a single fiber, multiple lasers with different wavelengths have to be packaged together and coupled into a single fiber. Thus, a cost effective optical subassembly will be the key enabling device for stacking multiple wavelength light source to existing fibers.

There are different techniques to integrate multiple lasers with different wavelengths. One is monolithic integration. It includes multiple laser sources integrated with a wavelength division multiplexing (WDM) component [For example, U.S. Pat. No. 6,434,175 by Zah et al, U.S. Pat. No. 7,058,246 by Joyner et al]. Mostly, Arrayed Waveguide Grating (AWG) is used as WDM component. Lasers and AWG are monolithically grown on the same wafer. This design is very compact and easy for packaging. The challenging is how to build multiple components on the same wafer. Especially, growing active multiple lasers with large wavelength span and passive AWG on the same wafer is not trivial. Thus, this technique mostly is used for dense wavelength division multiplexing (DWDM) with small wavelength span. For multiple lasers with a large wavelength span, a hybrid approach is used. The lasers and the AWG are fabricated separately then coupled with the input waveguides of an AWG [U.S. Pat. No. 8,639,070 by Neilson et. al]. With hybrid integration, the packaging has to be achieved in chip level that is very complicate and needs sophisticate alignment tools. In addition, AWG itself is expensive and the insertion loss is high. The third approach is free space optics based packaging technique. Instead of using AWG, free space wavelength division multiplexing (WDM) filters are used to achieve multiple wavelength multiplexing [U.S. Pat. No. 7,184,621 by Zhu]. Three 45 degree WDM filters are used to combine four different wavelength lasers. By adjusting laser position, the four lasers can be coupled into a single output fiber. This WDM filter based approach is cost effective and no expensive assembling equipment needed. The drawback is that the whole assembly is bulky and may not suitable for small footprint transceivers, such as QSFP that is a standard format for 40G/100G optical network. In addition, when the wavelength span gets small, the WDM filter is getting hard to make and expensive. U.S. Pat. No. 8,625,989 by Tang et al demonstrates another approach to combine multiple lasers by polarization beam combiners (PBC). However, multiple half waveplates are required to change the polarization direction of the lasers and each laser needs its own collimating lens. Those extra components not only increase the material cost significantly, but also make the packaging of the whole assembly much more complicate and difficult. Thus, it is apparent that a need exists for a new packaging technique to provide a compact and cost effective assembly of multiple lasers for high speed communication network. The present invention is directed toward providing such a technique.

### SUMMARY OF THE INVENTION

It is an object of the present invention to provide a method and a system for the assembly of multiple lasers. It is also an object of the present invention to provide a method and a system for multiple laser assembly that requires a compact and cost effective package suitable for small footprint transceivers. A further object of the present invention is to provide a technical solution that utilizes commercial available tools and existing infrastructure to mass produce multiple laser assembly. These and other objects of the invention will be apparent to those skilled in the art from a consideration of the following detailed description with reference of the accompanying drawings.

A preferred embodiment of two laser optical assembly according to the invention compromises two lasers, a polarization beam combiner (PBC), a lens, a mechanical housing and a fiber assembly. Two lasers are bonded to the bases of two different subassemblies with same or different wavelengths respectively. The beam directions from two lasers are perpendicular. The polarization direction of the first laser is perpendicular to the polarization direction of the second laser. PBC is mounted on the subassembly of the first laser between the lasers and the lens. The subassembly of the first laser has a through hole in the center area of the base to allow the second laser pass through. Two laser beams from the first and the second lasers are combined by PBC and are coupled into the output fiber by the same lens. During the assembly process, the first assembly is attached to the mechanical housing first and is aligned to couple the laser beam of the first laser into the output fiber. The light from the second laser is aligned to couple the laser beam of the second laser into the same output fiber. The second assembly is fixed to the first assembly or to the mechanical housing coaxially.

Another preferred embodiment of multiple laser optical assembly with four lasers according to the invention is characterized in that the four lasers with different wavelengths are coupled into a single mode fiber by the combination of polarization and wavelength division multiplexing. The multiple laser optical assembly compromises four lasers, two PBCs, two lenses, a mechanical housing and a WDM filter. The four lasers are mounted on four bases of four subassemblies. The first PBC is positioned between the first/the second lasers and the first lens. The second PBC is positioned between the third/the fourth lasers and the second lens. The subassemblies of the first laser and the second laser are assembled coaxially. The first and the second lasers are arranged with orthogonal polarization directions and are combined by the first PBC. The combined beam passes through the first lens and WDM filter and couples into the output fiber. The polarization direction of the third and the fourth lasers are also arranged orthogonally, and the corresponding subassemblies are assembled coaxially. The light beams from the third and the fourth lasers are combined by the second PBC and are focused by the second lens. After being reflected by the WDM filter, the combined light beam from the third and the fourth lasers is combined with the light beam from the first and the second lasers and couples into the output fiber.

Compare to prior arts, the multiple laser optical assembly according to the present invention uses one lens for two lasers, instead of one collimating lens for each laser. Further, the subassemblies of the two lasers that share one lens are packaged coaxially and are configured to achieve orthogonal polarization directions that significantly reduce the assembly size. With coaxial configuration, the conventional low cost transistor outline (TO) can based transmitter optical subassembly packaging process can be applied to the invention directly. Thus, it offers a very compact and cost effective solution for the design and manufacturing of multiple laser assembly for high speed small foot print transceivers.

### BRIEF DESCRIPTION OF THE DRAWINGS

The present invention is illustrated by way of example, and not limitation, by the figures of the accompanying drawings in which like reference indicate similar elements and in which:

FIG. 1 is a schematic representation of a preferred embodiment of a two laser optical assembly.

FIG. 2 is a schematic representation of the laser subassembly with a transparent material in the center of the base.

FIG. 3 is a schematic representation of another preferred embodiment of a two laser optical assembly with lens attached to the mechanical housing.

FIG. 4 is a schematic representation of another preferred embodiment of a two laser optical assembly with both laser subassemblies attached to the mechanical housing.

FIG. 5 is a schematic representation of a preferred embodiment of a four laser optical assembly.

FIG. 6 is a schematic representation of another preferred embodiment of a four laser optical assembly with collimating coupling configuration.

FIG. 7 is a schematic representation of a preferred embodiment of an eight laser optical assembly

### DETAILED DESCRIPTION

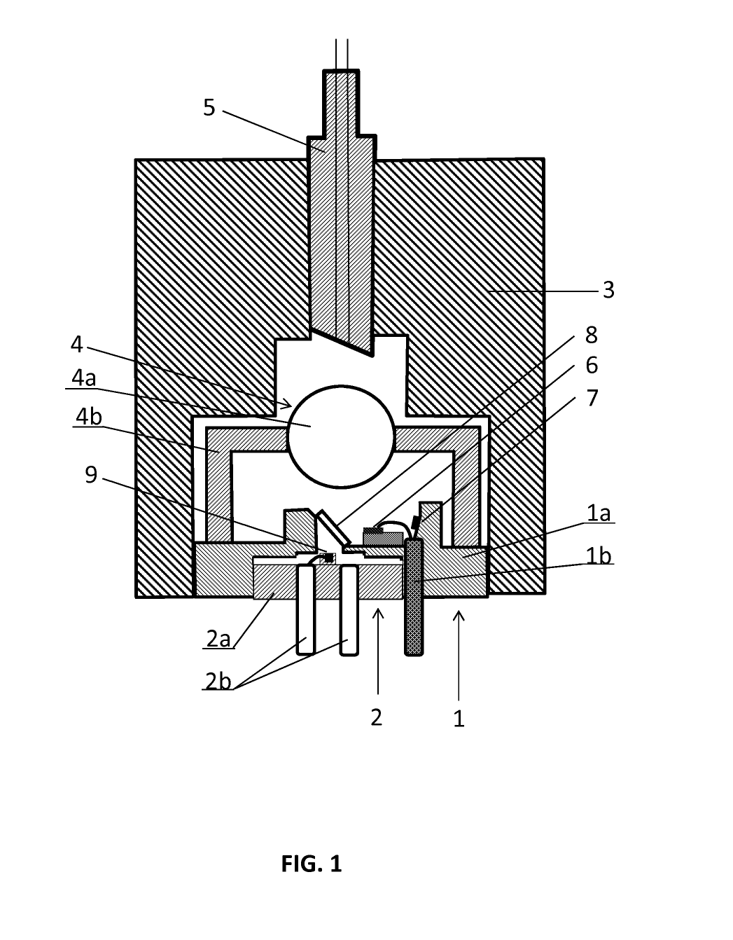

FIG. 1 schematically illustrates a first embodiment of a two laser optical assembly according to the invention. The two laser optical assembly compromises two laser subassemblies 1 and 2, a mechanical housing 3, a lens assembly 4 and a fiber assembly 5.

As disclosed in FIG. 1, the laser subassembly 1 comprises the first laser 6 mounted on a base 1a, a monitor photodiode (PD) 7, the leads 1b to provide the electrical connection for the first laser 6 and the monitor PD 7 (only one lead is shown, generally, multiple leads are needed), and a polarization beam combiner (PBC) 8 that is attached to the base 1a. The laser beam from the first laser 6 is parallel to the surface of the base 1a. The polarization direction of the first laser is perpendicular to the incident plane of PBC 8, i.e., it is S-polarized light and is reflected by PBC 8. The first laser assembly 1 can be a transistor outline (TO) can type. The base 1a has a through hole in the center area that allows the second laser 9 pass through to achieve coaxial package. The lead 1b can be glass sealed with the base 1a or a ceramic feedthrough with high speed transmission lines.

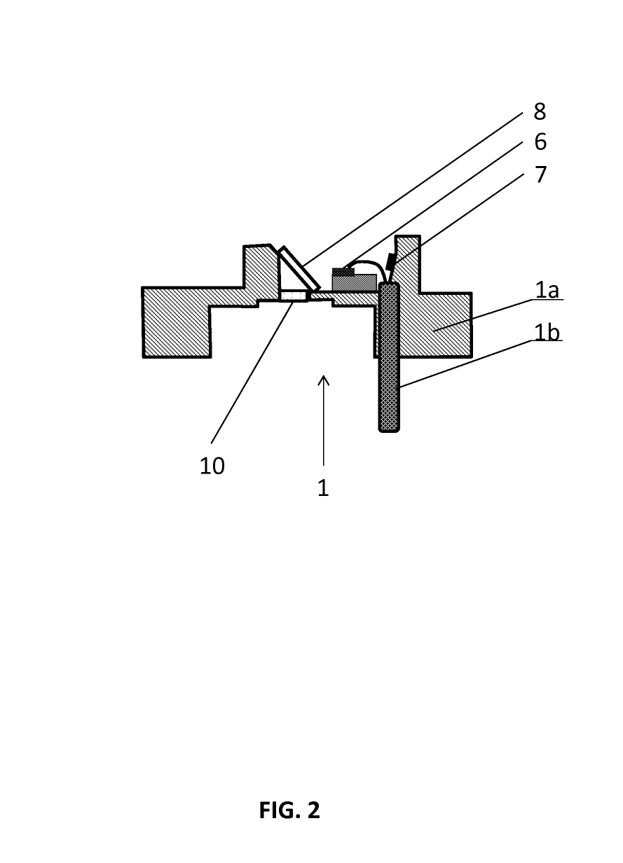

As disclosed in FIG. 1, the laser subassembly 2 comprises a base 2a, the second laser 9 mounted on a stem of the base 2a (a submount is usually needed to mount the laser on the stem which is not shown in FIG. 1), a monitor PD that is not shown in FIG. 2, and the leads 2b (two leads are shown, generally, multiple leads are needed) to provide electrical connection for the second laser 9 and the monitor PD. The first and second lasers 6 and 9 may have different wavelengths. However, the first and second lasers 6 and 9 may have the same wavelength. The second laser subassembly 2 can be a standard TO can laser assembly as well. The second laser 9 is positioned under PBC 8. The laser beam from the second laser 9 is perpendicular to the base 2a, also perpendicular to the laser beam from the first laser 6. The second laser 9 passes the through hole in the center of the base 1a. The second laser 9 may protrude above the base 1a depending on the focal length of the lens 4a. The polarization direction of the second laser 9 is arranged to parallel to the incident plane of PBC 8, i.e., it is P-polarized light and passes through PBC 8. Thus, the first laser 6 and the second laser 9 have orthogonal polarization states and both laser beams will be combined by PBC 8. The lens assembly 4 has a lens 4a and a holder 4b. The lens 4a is used to couple light from the first and the second lasers into the output fiber assembly 5. During the packaging process, the subassemblies 1 and 2 are assembled first by standard chip and wire bonding. The PBC 8 is mounted on the subassembly 1. The lens assembly 4 can be welded to the base 1a by standard TO can process. The subassembly 1 and the fiber assembly 5 are aligned to couple the light from the first laser 6 into the output fiber and fixed to the mechanical housing 3 by welding or epoxy. Finally, the subassembly 2 is aligned and attached to the first subassembly 1. By sealing the gap between the bases 1a and 2a, the hermetical sealing can be achieved if needed.

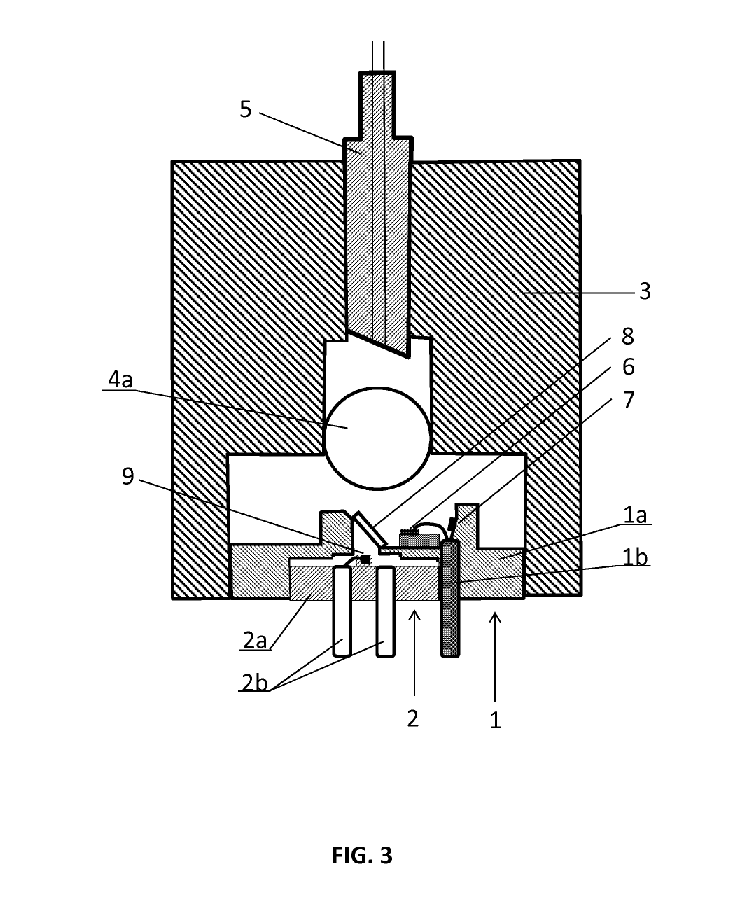

It is worthy of note that the through hole in the center of the base 1a, which allows the second laser 9 pass through, can be replaced by a transparent material 10 as shown in FIG. 2 provided that the focal length of the lens 4a is long enough. The transparent material may be glass, silicon or other materials that is transparent to the second laser 9. This configuration may offer hermetical sealing for the laser subassembly 1. If hermetical sealing is not necessary, the lens holder 4b may not be needed. The lens 4a can be attached to the mechanical housing 3 directly for cost saving, as shown in FIG. 3. An optical isolator may be inserted between the lens 4a and the fiber assembly 5 to minimize the back reflection from outside.

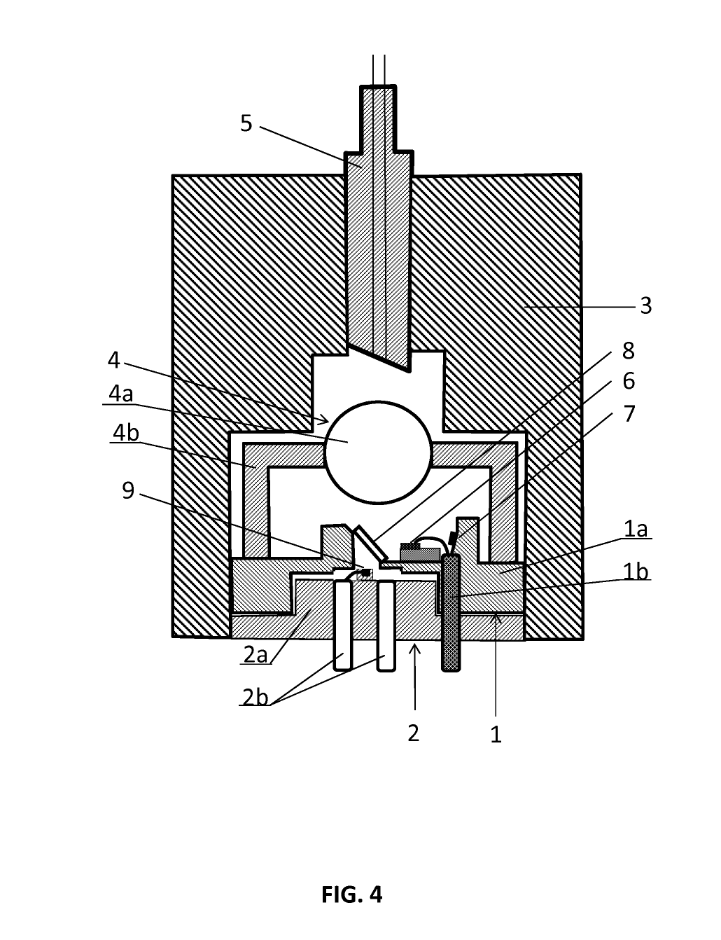

FIG. 4 illustrates an alternative embodiment of two laser optical assembly with the second laser subassembly 2 attached to the mechanical housing 3, instead of attaching to the first laser subassembly 1 as in FIG. 1. This configuration may make the welding of the second laser subassembly 2 simple and make the whole assembly more robust.

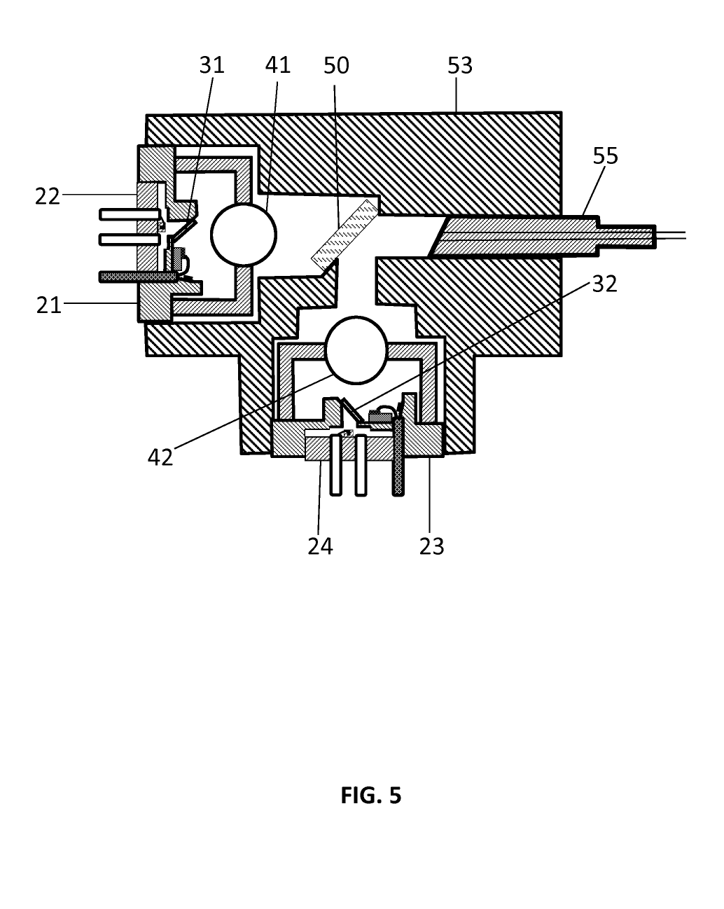

FIG. 5 schematically illustrates an embodiment of a four laser optical assembly according to the invention. The four laser optical assembly compromises four laser subassemblies 21, 22, 23 and 24, two PBCs 31 and 32, two lenses 41 and 42, a WDM filter 50, a mechanical housing 53 and a fiber assembly 55.

Similar as the laser subassembly 1 in FIG. 1, the laser subassembly 21 compromises the first laser mounted on a base, a monitor PD, the leads and a PBC 31; the laser subassembly 23 compromises the third laser mounted on a base, a monitor PD, the leads and a PBC 32. Same as the laser subassembly 2 in FIG. 1, the laser subassembly 22 compromises the second laser mounted on a stem of a base, a monitor PD and the leads; the laser subassembly 24 compromises the fourth laser mounted on a stem of a base, a monitor PD and the leads as well. The first and the second laser are arranged to have orthogonal polarization directions and the same orthogonal polarization arrangement is applied to the third and the fourth lasers. The first, the second, the third and the fourth lasers have different wavelengths. Depending on WDM filters, the wavelengths of the first and the second lasers are shorter (or longer) than that of the third and the fourth lasers. WDM filter 50 is attached to the mechanical housing 53 with an angle around 45 degrees to the incident light beams. WDM filter 50 reflects long wavelength light and passes short wavelength light, or vice versa. In the preferred embodiment shown in FIG. 5, the light from the first laser is combined with the light from the second laser by PBC 31. The combined beam from the first and the second laser is focused by the lens 41, passes through WDM filter 50 and couples into the output fiber; the light from the third laser is combined with the light from the fourth laser by PBC 32. The combined beam from the third and the fourth laser is focused by the lens 42, reflected by WDM filter 50 and couples into the same output fiber;

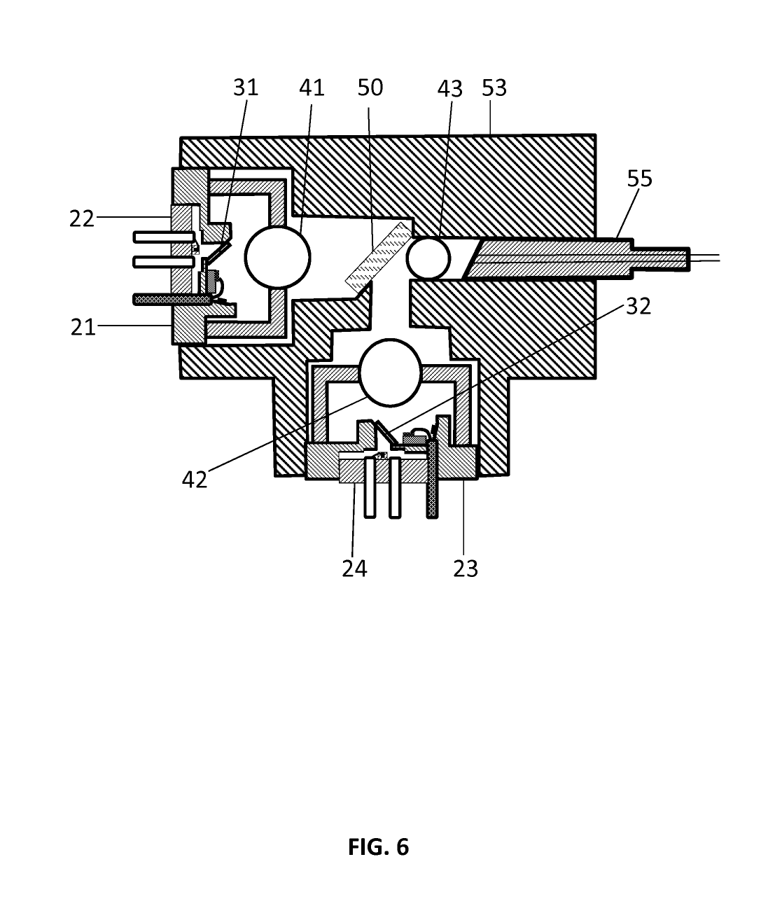

FIG. 6 is another preferred embodiment of a four laser optical assembly. Generally, the WDM filter 50 is very sensitive to the beam incident angle, i.e., the transition edge of the WDM filter 50 shifts with the change of the incident angle. In the preferred embodiment shown in FIG. 5, the incident beam is not collimated. Such arrangement is fine for a large wavelength span. Once the wavelength span gets small, it will be very challenging to make a WDM filter 50 to pass through the light from the first and the second lasers and reflect the light from the third and the fourth laser. One can use two lens coupling system to have a collimate beam to alleviate the requirement for the WDM filter 50. In FIG. 6, an extra lens 43 is attached to the mechanical housing. The first lens 41 is positioned to collimate the combined beam from the first and the second lasers; the second lens 42 also collimates the combined beam from the third and the fourth lasers. Both collimated beams are combined by the WDM filter 50. Finally, the third lens 43 focuses the combined collimated beam into the output fiber.

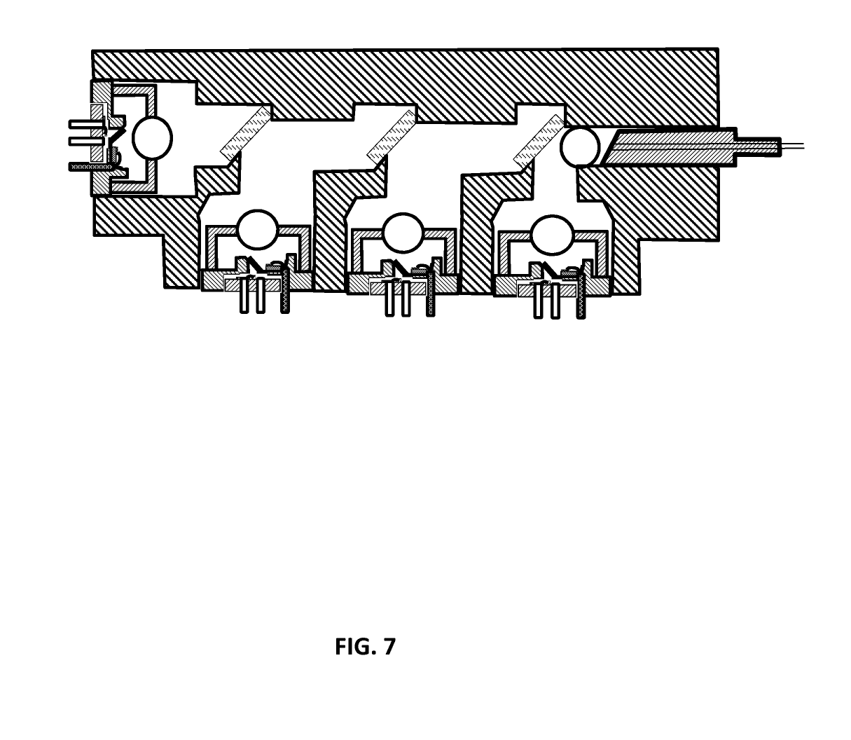

In the foregoing specification, the invention has been described with reference to specific exemplary embodiments thereof. It will, however, be understood by those skilled in the art that various other modifications and changes may be made, and equivalents may be substituted, without departing from the broader spirit and scope of the invention. For example, the four laser optical assembly can be easily extended to six, eight even more laser assembly by adding one, two and more extra WDM filters. FIG. 7 shows an example of an eight laser optical assembly configuration. In the embodiments illustrated in FIG. 1, each laser has its own subassembly to facilitate the alignment. If the laser chip placement accuracy can be well controlled in submicron level, the two lasers can be placed in the same subassembly to make the whole assembly more compact. Other alternatives include replacing the PBC and/or WDM filter with beam splitters with a splitting ratio about 50/50, although a significant optical power may be lost with a beam splitter. Therefore, it is intended that the present invention is not be limited to the particular embodiments disclosed, but that the invention include all embodiments falling within the scope of the appended claims.

What is claimed is:

1. A multiple laser optical assembly comprising:
first and second laser subassemblies including first and second bases with first and second lasers bonded on respectively, wherein the beam direction from said first laser is perpendicular to the beam direction from said second laser;
a polarization beam combiner (PBC);
an optical fiber;
a lens positioned between said PBC and said optical fiber;
a mechanical housing that at least one of said first and second laser subassemblies is attached to,
wherein said first and second laser subassemblies are configured to have orthogonal polarization directions from said first and said second lasers, said PBC is configured to combine the orthogonal polarized beams from said first and second lasers, and the combined beam passes through said lens and couples into said optical fiber.

2. The multiple laser optical assembly as claimed in claim 1 wherein said first and second laser subassemblies are assembled coaxially.

3. The multiple laser optical assembly as claimed in claim 1 wherein a through hole is in the center of said first base of said first laser subassembly.

4. The multiple laser optical assembly as claimed in claim 1 wherein said the center area of said first base of said first laser subassembly is transparent to the light from said second laser.

5. The multiple laser optical assembly as claimed in claim 3 wherein said second laser passes through said through hole.

6. The multiple laser optical assembly as claimed in claim 1 wherein said PBC is mounted to said first laser subassembly.

7. The multiple laser optical assembly as claimed in claim 1 wherein said first and second laser subassemblies are TO can packages.

8. The multiple laser optical assembly as claimed in claim 1 wherein said second laser subassembly is attached to said first laser subassembly coaxially.

9. The multiple laser optical assembly as claimed in claim 1 wherein said first and said second laser assemblies are attached to said mechanical housing coaxially.

10. The multiple laser optical assembly as claimed in claim 1 wherein said PBC is replaced with a beam splitter with a splitting ratio about 50/50.

11. A multiple laser optical assembly comprising:
first, second, third and fourth laser subassemblies including first, second, third and fourth bases with first, second, third and fourth lasers boned on respectively, wherein the beam direction from said first laser is perpendicular to the beam direction from said second laser and the beam direction from said third laser is perpendicular to the beam direction from said fourth laser;
a first and second polarization beam combiners (PBC);
a first and second lenses;
an optical fiber;
a wavelength division multiplexing (WDM) filter;
a mechanical housing that at least two of said first, second, third and fourth laser subassemblies are attached to,
wherein said first and second laser subassemblies are configured to have orthogonal polarization directions of said first and second lasers, said first PBC is configured to combine the orthogonal polarized beams from said first and second lasers, and the combined beam of said first and second lasers passes through said first lens; said third and fourth laser subassemblies are configured to have orthogonal polarization directions of said third and fourth lasers, said second PBC is configured to combine the orthogonal polarized beams from said third and fourth lasers, and the combined beam of said third and fourth lasers passes through said second lens; said WDM filter is configured to combine the two combined beams from said first/second lasers and said third/fourth lasers, the combined beam is coupled into said optical fiber.

12. The multiple laser optical assembly as claimed in claim 11 wherein said first, second, third and fourth lasers have different wavelengths.

13. The multiple laser optical assembly as claimed in claim 11 wherein said first and second laser subassemblies are assembled coaxially and said third and fourth laser subassemblies are assembled coaxially.

14. The multiple laser optical assembly as claimed in claim 11 wherein a through hole is in the center of said first base of said first laser subassembly and another through hole is in the center of said third base of said third laser subassembly.

15. The multiple laser optical assembly as claimed in claim 14 wherein said second laser passes through said through hole of said first base of said first laser subassembly and said fourth laser passes through said through hole of said third base of said third laser subassembly.

16. The multiple laser optical assembly as claimed in claim 11 wherein said WDM filter is mounted to said mechanical housing with about 45 degree angle.

17. The multiple laser optical assembly as claimed in claim 11 wherein said WDM filter is replaced with a beam splitter with a splitting ratio about 50/50.

18. The multiple laser optical assembly as claimed in claim 11, further comprising a third lens positioned between said WDM filter and said optical fiber wherein said first lens collimates the combined beam from said first and said second lasers, and said second lens collimates the combined beam from said third and said fourth lasers, said WDM filter combines the two combined collimated beams, said third lens serves as focusing lens to couple the combined beam into said optical fiber.

19. A multiple laser optical assembly comprising:
2N laser subassemblies including 2N bases with 2N lasers boned on respectively, where N is no less than 3;
N polarization beam combiners (PBC);
N collimating lenses;
a focusing lens;
N−1 wavelength division multiplexing (WDM) filter;
an optical fiber;
a mechanical housing that provides the mechanical support for at least N of said 2N subassemblies and said optical fiber,
wherein two laser subassemblies with adjacent wavelengths of said 2N lasers are configured to have orthogonal polarization directions and are assembled coaxially, one of said N PBCs is configured to combine the orthogonal polarized beams from said two laser subassemblies with adjacent wavelengths, and the combined beam of said two lasers with adjacent wavelengths passes through said one of said N collimating lenses and becomes combined collimated beam, said 2N lasers with said N PBCs and said N collimating lenses forms N combined collimated beams, said N−1 WDM filters are configured to combine N combined beams into one combined beam that is coupled into said optical fiber by said focusing lens.
